(19) United States
(12) Patent Application Publication
(10) Pub. No.: US 2002/0035595 A1
(43) Pub. Date: Mar. 21, 2002

(54) Method and system for generating user interfaces

(76) Inventors: Hsiang Tsun Yen, Taipei (TW); Chien Sen Weng, Taipei (TW); Luke Taylor, Taipei (TW)

Correspondence Address: Michael D. Bednarek, SHAWPITTMAN, 1650 Tysons Boulevard, McLean, VA, 22102-4859, US

(21) Appl. No.: 09/823,759

(22) Filed: Apr. 3, 2001

(30) Foreign Application Priority Data
Sep. 14, 2000 (TW) 089119024

(51) Int. Cl. G06F 15/16; G06F 15/173

(52) U.S. Cl. 709/203; 709/238

(57) ABSTRACT

A method and system for generating dynamic user interfaces is disclosed herein. A client makes a request to a server for generating a user interface. Thereupon receiving the request, the server transfers a frame and a configuration file to the client in return. The configuration file comprises a plurality of filenames, file addresses and file coordinates. Each filename corresponds to a file address and a file coordinate. Each file address corresponds to a storage apparatus. The file coordinates are used to designate the positions of the files on the frame. Upon the client receiving the frame and the configuration file, the client links to the storage apparatus corresponding to the file addresses and downloads the files corresponding to the filenames. The client generates a user interface within the frame by displaying the downloaded files based on the file coordinates corresponding to the filenames in the configuration file.

### REFERENCE TO RELATED APPLICATIONS

The present application claims priority to Taiwan application No. 089119024, entitled “Method and System for Generating User Interfaces,” filed on Sep. 14, 2000.

### BACKGROUND OF THE INVENTION

1. Field of the Invention

This invention generally relates to a user interface generating method and system, and in particular to a method and system for dynamically generating user interfaces.

2. Description of the Related Art

Today, as is well known, graphical user interfaces play an important role in computer applications. Users are familiar with user interfaces in multimedia forms. Due to the rapid spread of computer applications enabled by the Internet, the users demand greater diversity and functionality on user interfaces. When users download an application from a server end to a client computer, files used to form the user interface of this application are downloaded simultaneously and stored. Accordingly, when the application is launched, the downloaded files are initialized from the client computer to generate a user interface for the application.

### SUMMARY OF THE INVENTION

The object of the invention is to provide a method and system for dynamically generating user interfaces. The invention provides files stored in a server for generating a user interface, and the files are accessible from a client computer so that the client computer can download the files to generate the user interface.

In a preferred embodiment, the present invention provides a method and system for generating dynamic user interfaces. When a client computer makes a request to a server end for generating a user interface, thereupon receiving the request, the server end transfers a frame and a configuration file to the client computer in return. The configuration file comprises a plurality of filenames, a plurality of file addresses and a plurality of file coordinates. Each filename corresponds to one of the file addresses and one of the file coordinates. Each file address corresponds to a storage apparatus where the file corresponding to the filename is located. The file coordinates are used to designate the positions of the files on the frame. As a result, upon the client computer receiving the frame and the configuration file, according to the file addresses corresponding to the filenames in the configuration file, the client computer links to the storage apparatus corresponding to the file addresses and downloads the files corresponding to the filenames. Consequently, the client computer generates a user interface withon the frame by displaying the downloaded files based on the file coordinates corresponding to the filenames in the configuration file.

It is an advantage of the present invention that the files used to generate a user interface are stored in the server or an external server. Therefore, the server controls the user interface displayed on the client computer. The invention enables an interrelation between the content part user and layout part of the interface. Furthermore, the users can choose and individualize the user interface to meet their demands and preferences by using the driver modules of the system according to the present invnetion.

These and other objectives of the present invention will no doubt become obvious to those of ordinary skill in the art after having read the following detailed description of the preferred embodiment, which is illustrated in the various figures and drawings.

### BRIEF DESCRIPTION OF THE DRAWINGS

The following detailed description which is given by way of example, and not intended to limit the invention to the embodiments described herein, can best be understood in conjunction with the accompanying drawings, in which:

FIG. 1 illustrates a system diagram of one preferred embodiment of the invention;

FIG. 2 illustrates a configuration file diagram of one preferred embodiment of the invention;

FIG. 3a illustrates a diagram where a user interface is displayed on a frame in a system according to one preferred embodiment of the invention;

FIG. 3b illustrates a diagram of a user interface according to one preferred embodiment of the invention;

FIG. 4 illustrates a flowchart of a user interface according to one preferred embodiment of the invention;

FIG. 5 illustrates a flowchart of the first method for updating a user interface according to one preferred embodiment of the invention;

FIG. 6 illustrates a flowchart of the third method for updating a user interface according to one preferred embodiment of the invention;

FIG. 7 illustrates a flowchart of the fourth method for updating a user interface according to one preferred embodiment of the invention;

FIG. 8 illustrates a diagram of a content configuration file according to one preferred embodiment of the invention;

FIG. 9 illustrates a flowchart of the fifth method for updating a user interface according to one preferred embodiment of the invention;

FIG. 10 illustrates a flowchart of the sixth method for updating a user interface according to one preferred embodiment of the invention;

FIG. 11 illustrates a diagram of a layout configuration file according to one preferred embodiment of the invention;

FIG. 12 illustrates a flowchart of the seventh method for updating a user interface according to one preferred embodiment of the invention;

FIG. 13 illustrates a flowchart of the eighth method for updating a user interface according to one preferred embodiment of the invention;

FIG. 14 illustrates a flowchart of the tenth method for updating a user interface according to one preferred embodiment of the invention;

FIG. 15 illustrates a flowchart of the eleventh method for updating a user interface according to one preferred embodiment of the invention; and

FIG. 16 illustrates a flowchart of the twelfth method for updating a user interface according to one preferred embodiment of the invention.

### DETAILED DESCRIPTION OF THE INVENTION

The invention provides multi-platform support by utilizing the HTTP communication protocol as a means to communicate between client computer and the server. In addition, combined with DHTML technology, the invention provides a method and system to fetch XML files on a server via a browser engine and parse the XML files with Javascript technology, and renders diversified user interfaces.

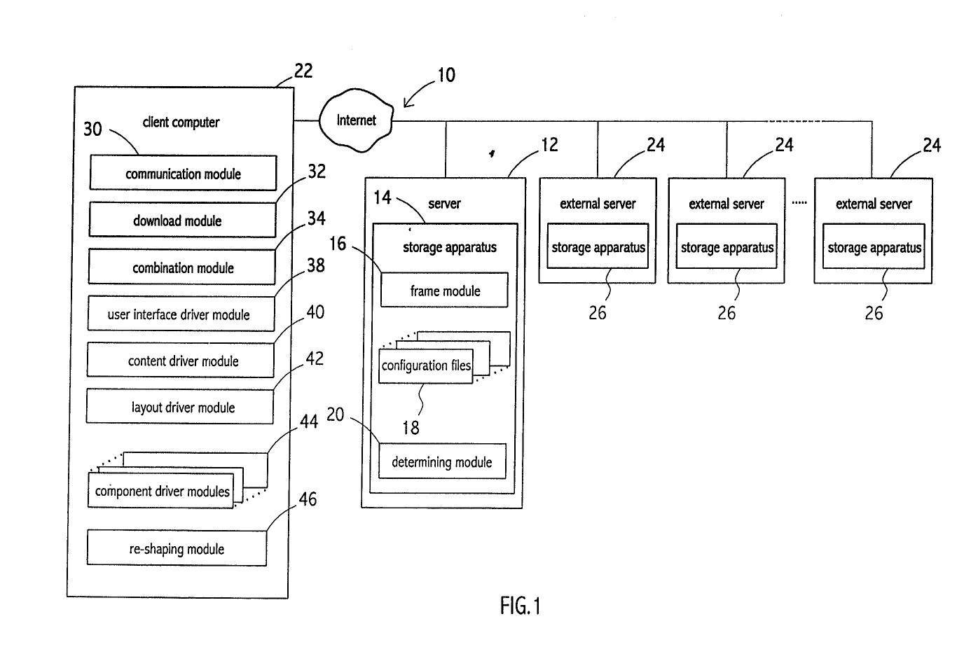

Refers to FIG. 1, it illustrates a diagram of system 10 in accordance with the invention. System 10 comprises a server 12, a client computer 22 and a plurality of external servers 24. The server 12 comprises a storage apparatus 14, a frame module 16, a plurality of configuration files 18 and a determining module 20. Each external server 24 comprises a storage apparatus 26.

The client computer 22 comprises a communication module 30, a download module 32, a combination module 34, a user interface driver module 38, a content driver module 40, a layout driver module 42, a plurality of component driver modules 34 and a re-shaping module 46.

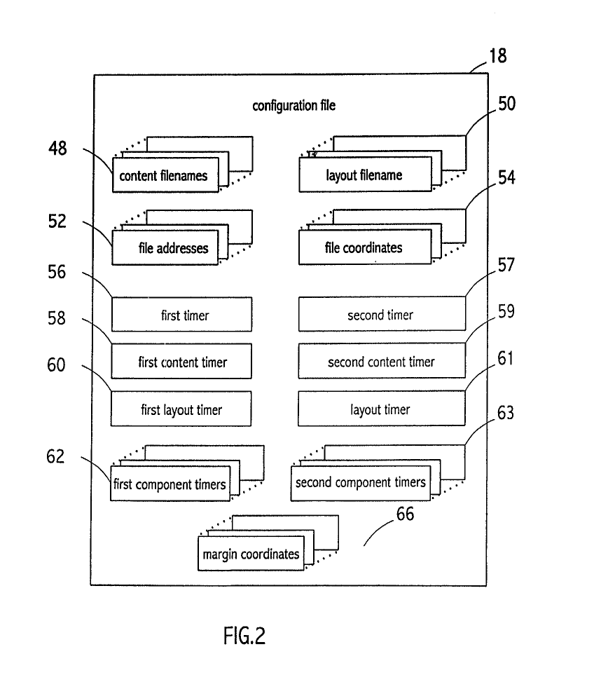

Refers to FIG. 2, it illustrates a diagram of a configuration file 18 in the system 10. The configuration file 18 comprises a plurality of content filenames 48, a plurality of layout filenames 50, a plurality of file addresses 52, a plurality of file coordinates 54, a first timer 56, a second timer 57, a first content timer 58, a second content timer 59, a first layout timer 60, a second layout timer 61, a plurality of first component timers 62, a plurality of second component timers 63 and a plurality of margin coordinates 66. Each of the content filenames 48 or the layout filenames 50 corresponds to a file address 52 and file coordinates 54 respectively. Each of the file addresses 52 corresponds to either storage apparatus 14 or storage apparatus 26. The content or layout files corresponding to the content filenames 48 or layout filenames 50 are stored in the storage apparatus 14 or 26.

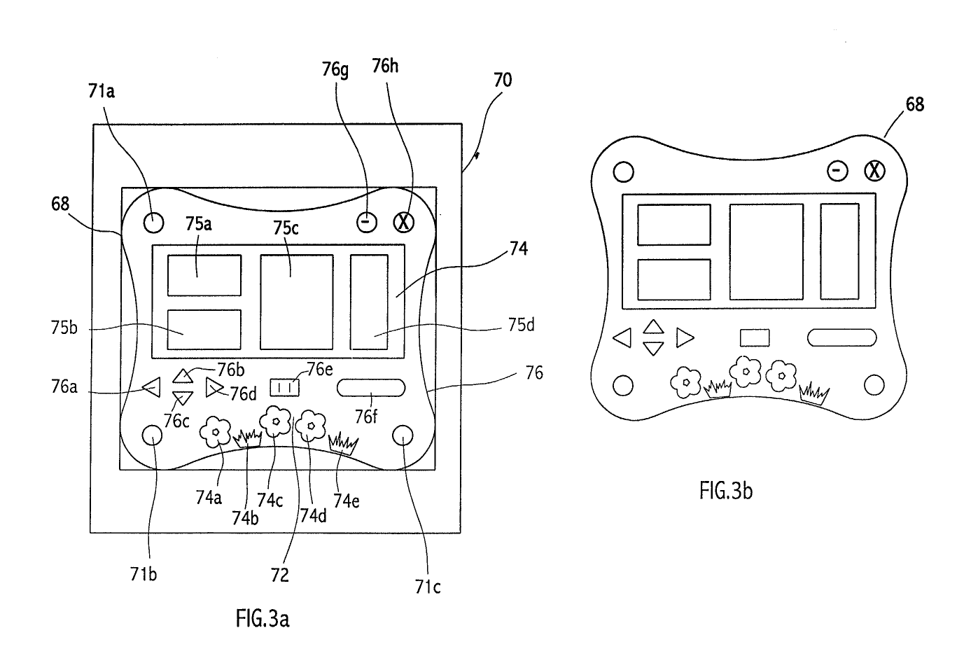

Refers to FIG. 3a, it illustrates a diagram of a user interface 68 displayed on a frame. The user interface 68 comprises a content part 74 and a layout part 72. The content files corresponding to the content filenames 48 in the configuration file 18 are used to generate the content part 74 of the user interface 68. The layout files corresponding to the layout filenames 50 are used to generate the layout part 72 of the user interface 68. File coordinates 54 are used to designate the location of the content files or the layout files on the frame 70. Moreover, the margin coordinates 66 are used to form a margin 76 on the frame 70 for designating the display region of the frame 70.

In the FIG. 3a, layout part 72 comprises a background, a plurality of images 74a to 74e and a plurality of function buttons 71a to 71c and 76a to 76g, where each of the background, the images and the function buttons corresponds to one of the layout title filse 50 respectively. The content part 74 comprises a background and a plurality of content display regions 75a to 75d. Each of the background and the content display regions corresponds to one of the content title filse 48 respectively.

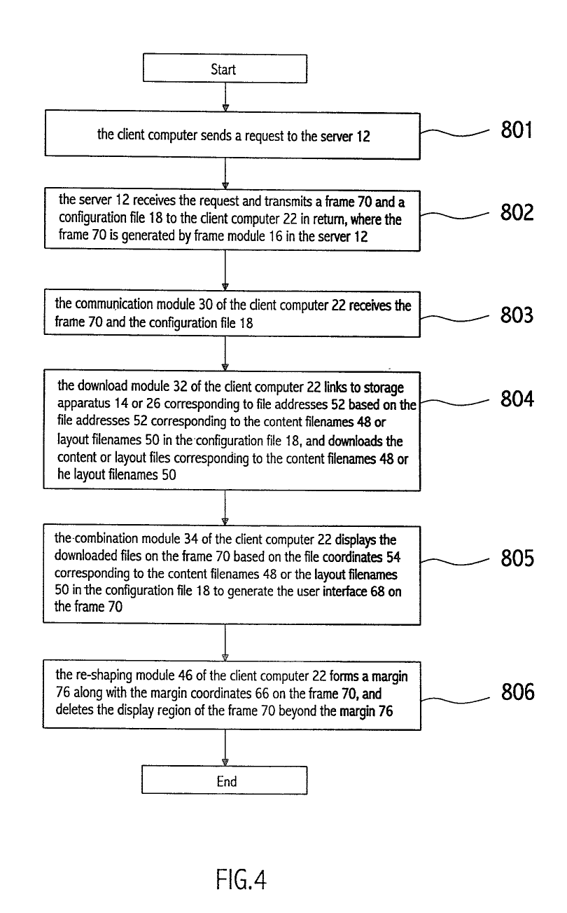

Refers to FIG. 4, it illustrates a flow chart of a method 80 in accordance with the invention. The method 80 comprises the following steps. At step 801, the client computer sends a request to the server 12. At step 802, the server 12 receives the request and transmits a frame 70 and a configuration file 18 to the client computer 22 in return, where the frame 70 is generated by frame module 16 in the server 12. At step 803, the communication module 30 of the client computer 22 receives the frame 70 and the configuration file 18. At step 804, the download module 32 of the client computer 22 links to storage apparatus 14 or 26 corresponding to file addresses 52 based on the file addresses 52 corresponding to the content filenames 48 or layout filenames 50 in the configuration file 18, and downloads the content or layout files corresponding to the content filenames 48 or the layout filenames 50. At step 805, the combination module 34 of the client computer 22 displays the downloaded files on the frame 70 based on the file coordinates 54 corresponding to the content filenames 48 or the layout filenames 50 in the configuration file 18 to generate the user interface 68 on the frame 70.

In the step 806, the re-shaping module 46 of the client computer 22 forms a margin 76 along with the margin coordinates 66 on the frame 70, and deletes the display region of the frame 70 beyond the margin 76.

Another alternative for step 806 is that re-shaping module 46 deletes the display region of the frame 70 beyond the overlapping display region of the user interface 68 and the frame 70 from client computer 22. Therefore, the configuration file 18 has not the margin coordinates 66.

Refers to FIG. 3b, it illustrates the user interface 68 after the display region of the frame 70 beyond the margin 76 is deleted by the re-shaping module 46 from the client computer 22.

With the method 80, the server 12 can control the user interface 68 display of the client computer 22. For example, when the client computer 22 makes a request in the morning, the server 12 will display a stock quote reporter from client computer 22 (which offers real time stocks quotes); when the client computer 22 makes a request in the afternoon, the server 12 then displays a stock market analysis reporter from client computer 22 (which offers stock market analysis on the same day).

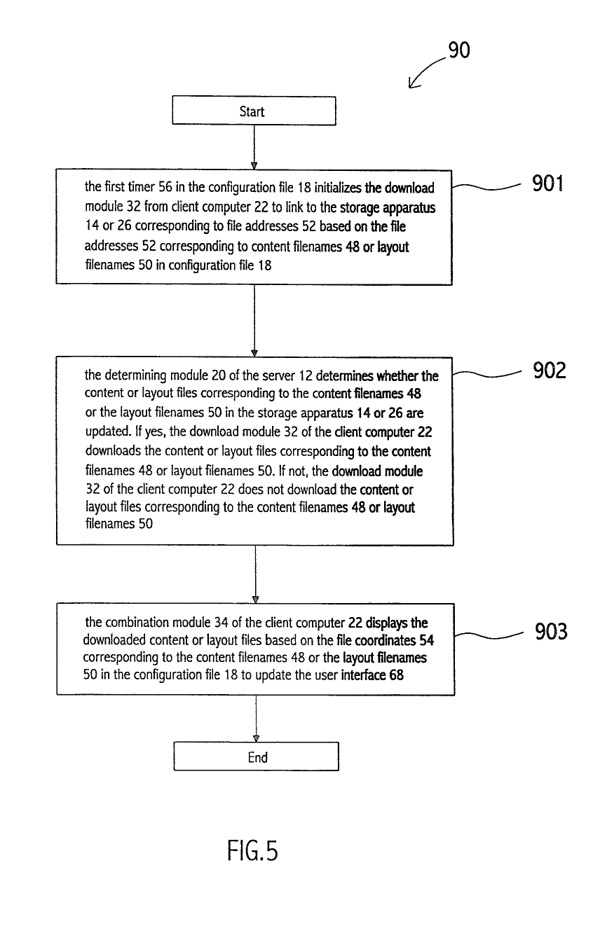

Refers to FIG. 5, it illustrates a flow chart of the first method 90 for updating the user interface 68. The method 90 comprises the following steps. At step 901, the first timer 56 in the configuration file 18 initializes the download module 32 from client computer 22 to link to the storage apparatus 14 or 26 corresponding to file addresses 52 based on the file addresses 52 corresponding to content filenames 48 or layout filenames 50 in configuration file 18. At step 902, the determining module 20 of the server 12 determines whether the content or layout files corresponding to the content filenames 48 or the layout filenames 50 in the storage apparatus 14 or 26 are updated. If yes, the download module 32 of the client computer 22 downloads the content or layout files corresponding to the content filenames 48 or layout filenames 50. If not, the download module 32 of the client computer 22 does not download the content or layout files corresponding to the content filenames 48 or layout filenames 50.

At step 903, the combination module 34 of the client computer 22 displays the downloaded content or layout files based on the file coordinates 54 corresponding to the content filenames 48 or the layout filenames 50 in the configuration file 18 to update the user interface 68.

As the content or layout files in the storage apparatus 14 or 26 are updated at preset times, the server 12 uses the first timer 56 to control the client computer to re-download the content or layout files to update the user interface 68. For example, the client computer 22 downloads the user interface of a stock quote reporter in the morning. That content or layout files in the storage apparatus 14 or 26 are updated in the afternoon, and then the server uses the first timer 56 to control the client computer 22 to link to the same storage apparatus as in the morning to download the updated content or layou files. As a result, the user interface of the stock quote reporter is automatically replaced with the user interface of the stock market analysis reporter.

In the second method, the second timer 57 in configuration file 18 is used for initializing the client computer 22 to update the user interface 68. Accordingly, the system 10 repeats the method 80 to update the user interface 68. The difference between the first and second methods lies in the fact that in the second method, the server 12 transfers a new frame and a new configuration file to the client computer 22; therefore, the shape of the user interface may vary due to the redefining of margin coordinates. For example, when the client computer 22 makes a request in the morning, under the control of server 12, the client computer 22 displays a user interface of daily news reporter (which delivers real-time daily news). Furthermore, the server 12 controls the client computer 22 to make a request in the afternoon by using the second timer 57 in configuration file 18 so that the client computer 22, according to the received configuration file (which is a new one), links to a different storage apparatus to download different content or layout files for updating the user interface, such as a evening news reporter (which delivers real-time evening news).

The server 12 also controls the client computer 22 to make the display part of the content part 74 interrelated to the layout part 72 of the user interface 68. In other words, the server 12 changes the layout part 72 based on the content part 74 of the user interface 68. For example, when the client computer 22 displays the user interface of a news reporter (which delivers real-time daily news), the layout part of the user interface can be changed based on the news stories in the content part through the control of server 12. For example, where the content part of the news reporter is entertainment based, perhaps regarding a movie star, then the layout of the news reporter can use a photo of the movie star as background. The server 12 can change both the content part 74 and the layout part 72 of the user interface 68 at the same time to establish a relation between them.

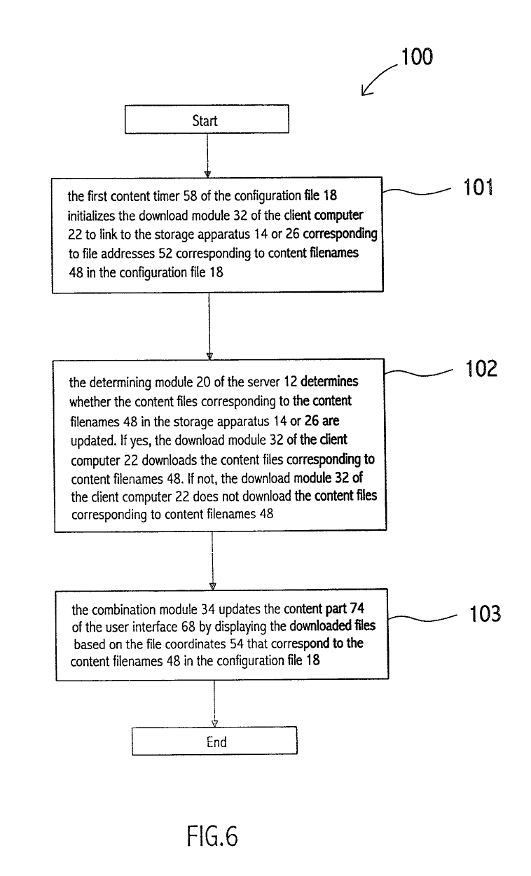

Refers to FIG. 6, it illustrates a flow chart of a third method 100 for updating the user interface 68. The first content timer 58 in configuration file 18 corresponds to the content filenames 48, and is used to update the content part 74 of user interface 68 at preset time. The method 100 comprises the following steps.

At step 101, the first content timer 58 of the configuration file 18 initializes the download module 32 of the client computer 22 to link to the storage apparatus 14 or 26 corresponding to file addresses 52 corresponding to content filenames 48 in the configuration file 18.

In the step 102, the determining module 20 of the server 12 determines whether the content files corresponding to the content filenames 48 in the storage apparatus 14 or 26 are updated. If yes, the download module 32 of the client computer 22 downloads the content files corresponding to content filenames 48. If not, the download module 32 of the client computer 22 does not download the content files corresponding to content filenames 48.

At step 103, the combination module 34 updates the content part 74 of the user interface 68 by displaying the downloaded files based on the file coordinates 54 that correspond to the content filenames 48 in the configuration file 18.

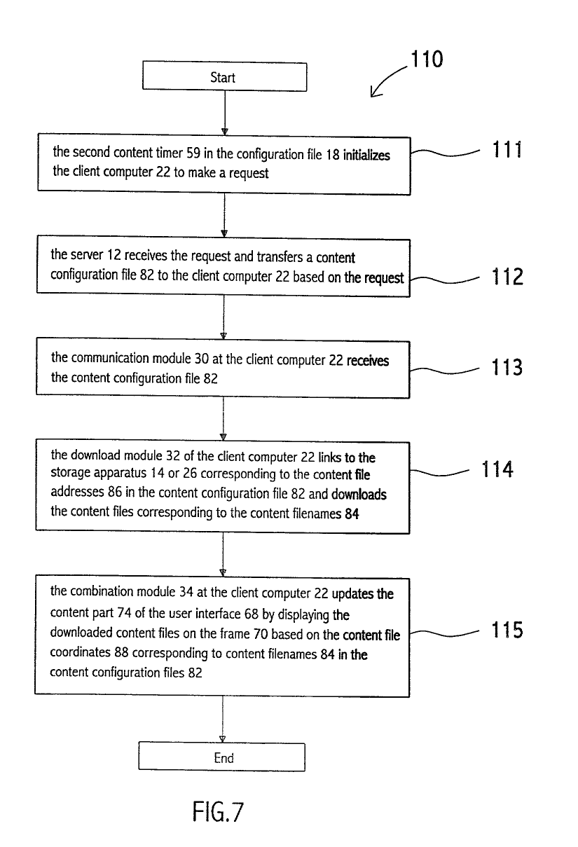

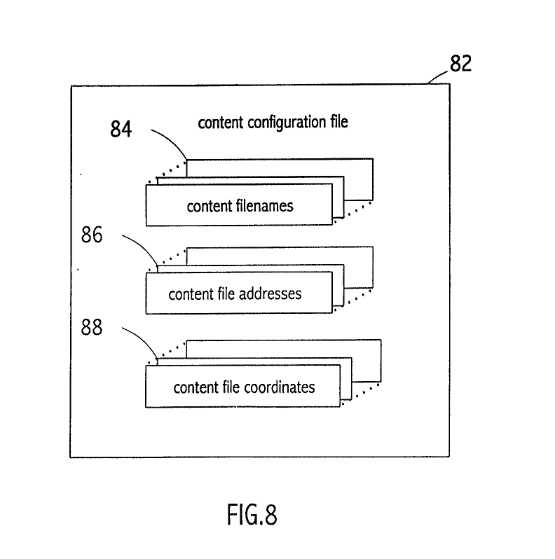

Refers to FIG. 7 and FIG. 8, FIG. 7 illustrates a flow chart of the fourth method 110 for updating user interface 68 and FIG. 8 illustrates a diagram of the content configuration file 82. The fourth method 110 comprises the following steps.

At step 111, the second content timer 59 in the configuration file 18 initializes the client computer 22 to make a request.

At step 112, the server 12 receives the request and transfers a content configuration file 82 to the client computer 22 based on the request. The content configuration file 82 comprises a plurality of content filenames 84, a plurality of content file addresses 86 and a plurality of content file coordinates 88. Each of the content filenames 84 corresponds to one content file address 86 and one content file coordinate 88. Each of the content file addresses 86 corresponds to a storage apparatus 14 or 26, where the content file corresponding to the content filename 84 is located, and the content file coordinates 88 are used to designate the location of the content files on the frame 70.

At step 113, the communication module 30 at the client computer 22 receives the content configuration file 82.

At step 114, the download module 32 of the client computer 22 links to the storage apparatus 14 or 26 corresponding to the content file addresses 86 in the content configuration file 82 and downloads the content files corresponding to the content filenames 84.

At step 115, the combination module 34 at the client computer 22 updates the content part 74 of the user interface 68 by displaying the downloaded content files on the frame 70 based on the content file coordinates 88 corresponding to content filenames 84 in the content configuration files 82.

The third method 100 and the fourth method 110 are both used to update the content part 74 of the user interface 68. For example, when the client computer 22 displays the user interface of a daily news reporter, the first or second content timer 58, 59 are used by the server 12 to control the client computer 22 to update the news content displayed on the daily news repoter at preset time, thereby broadcasting the real-time news.

In the third method 100, the server 12 updates the content file in the storage apparatus 14 or 26 at preset time, and uses the first content timer 58 to enable the client computer link to the same storage apparatus to download the updated content file. It then replaces the old content file with the new content file on the frame 70. For example, the third method 100 can be used to update either the content or background of each content display region at preset times.

In method fourth 110, the server 12 uses the second content timer 59 to enable the client computer 22 to make a request for updating the content part 74 of the user interface 68. The server 12 transfers a content configuration file based on the request to the client computer 22 for enabling the client computer to download the different content files and display them on the frame 70 to replace the old content part 74 as a way of generating new content display region and background.

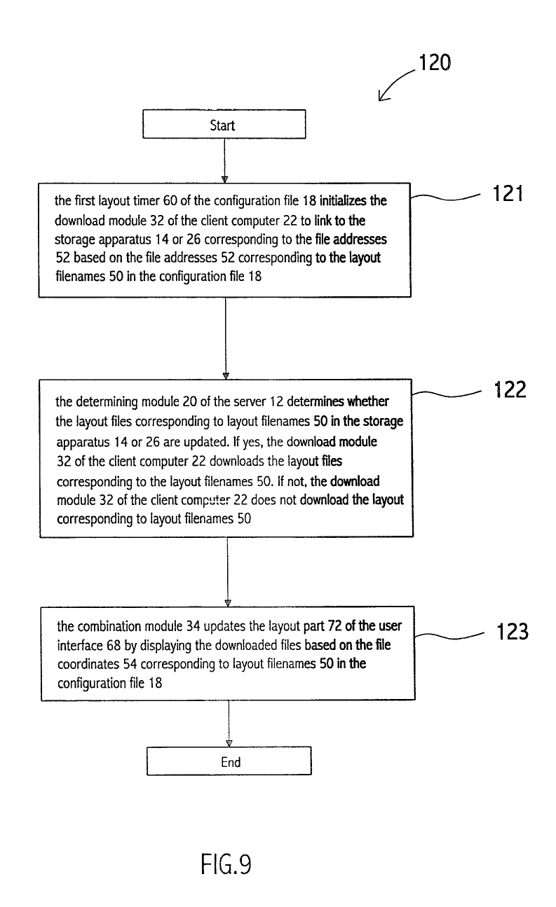

Refers to FIG. 9, it illustrates a flow chart of a fifth method 120 for updating the user interface 68 according to the present invention. The first layout timer 60 in configuration file 18 corresponds to the layout filenames 50 and is used to update the layout part 72 of the user interface 68 at preset times. The fifth method 120 comprises the following steps.

At step 121, the first layout timer 60 of the configuration file 18 initializes the download module 32 of the client computer 22 to link to the storage apparatus 14 or 26 corresponding to the file addresses 52 based on the file addresses 52 corresponding to the layout filenames 50 in the configuration file 18.

At step 122, the determining module 20 of the server 12 determines whether the layout files corresponding to layout filenames 50 in the storage apparatus 14 or 26 are updated. If yes, the download module 32 of the client computer 22 downloads the layout files corresponding to the layout filenames 50. If not, the download module 32 of the client computer 22 does not download the layout files corresponding to layout filenames 50.

In step 123, the combination module 34 updates the layout part 72 of the user interface 68 by displaying the downloaded files based on the file coordinates 54 corresponding to layout filenames 50 in the configuration file 18.

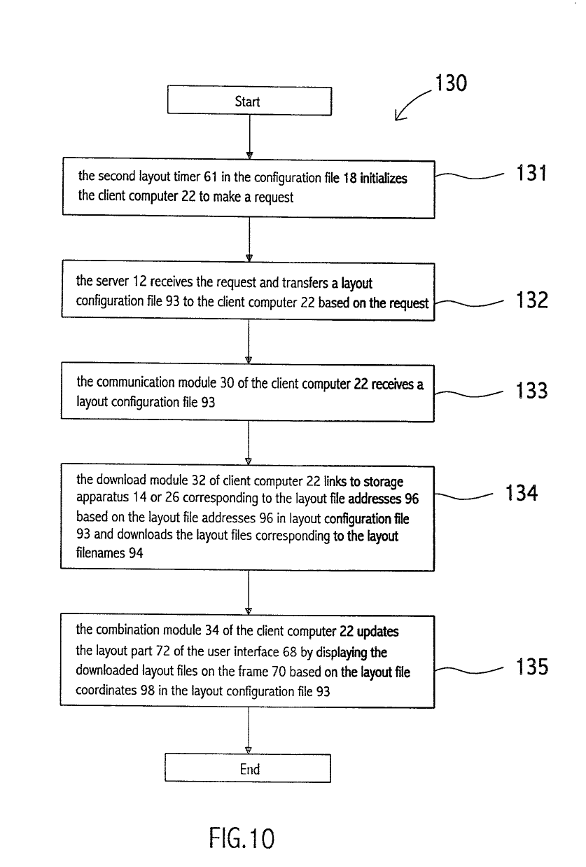

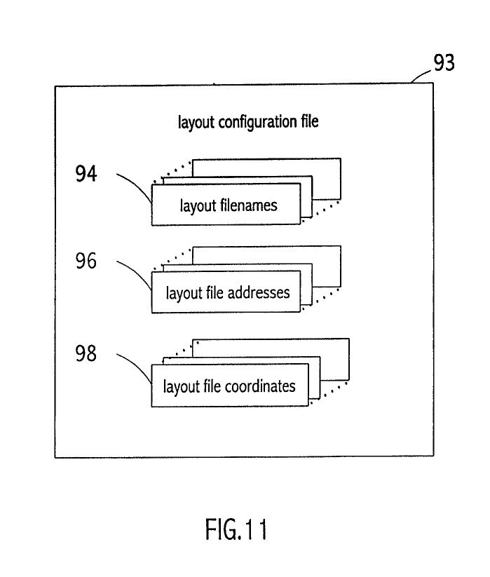

Refers to FIG. 10 and FIG. 11, FIG. 10 illustrates a flow chart of a sixth method 130 for updating the user interface 68 and FIG. 11 illustrates a diagram of a layout configuration file 93. The sixth method 130 comprises the following steps.

At step 131, the second layout timer 61 in the configuration file 18 initializes the client computer 22 to make a request.

At step 132, the server 12 receives the request and transfers a layout configuration file 93 to the client computer 22 based on the request. The layout configuration file 93 comprises a plurality of layout filenames 94, a plurality of layout file addresses 96 and a plurality of layout file coordinates 98. Each of the layout filenames 94 corresponds to one layout file address 96 and one layout file coordinates 98, and each of the layout file addresses 96 corresponds to a storage apparatus 14 or 26 where the layout file corresponding to the layout filename 94 is located. The layout file coordinate 98 is used to designate the location of the layout file on the frame 70.

At step 133, the communication module 30 of the client computer 22 receives a layout configuration file 93.

At step 134, the download module 32 of client computer 22 links to storage apparatus 14 or 26 corresponding to the layout file addresses 96 based on the layout file addresses 96 in layout configuration file 93 and downloads the layout files corresponding to the layout filenames 94.

At step 135, the combination module 34 of the client computer 22 updates the layout part 72 of the user interface 68 by displaying the downloaded layout files on the frame 70 based on the layout file coordinates 98 in the layout configuration file 93.

The fifth method 120 and the sixth method 130 are both used to update the layout part 72 of the user interface 68. The server 12 uses a first or a second layout timer 60-61 to enable the client computer 22 to update the layout part of the user interface.

In the fifth method 120, the server 12 updates the layout file in storage apparatus 14 or 26 at preset timess, and uses first layout timer 60 to enable the client computer to link to the same storage apparatus to download the updated layout file. The client computer then displays the new layout files on the frame 70. Changes in background, colors or the shapes of the images and functional buttons, can be made with method 120.

In sixth method 130, the server 12 uses the second layout timer 61 to enable the client computer 22 to make a request for updating the layout part 72 of the user interface 68. The server 12 transfers a content configuration file based on the request to the client computer 22 and enables the client computer to download a different content file. The client computer then replaces the old layout with a new layout on the frame 70. For example, when the client computer 22 displays the user interface of a news reporter, the server 12 uses a second layout timer 61 to update the layout 72 of the news repoter with different background, images and functional buttons. Consequently, when the user interface of the news reporter is displayed from client computer 22, the server 12 can control the client computer 22 with the second layout timer 61, updating the layout design and functions of the news reporter.

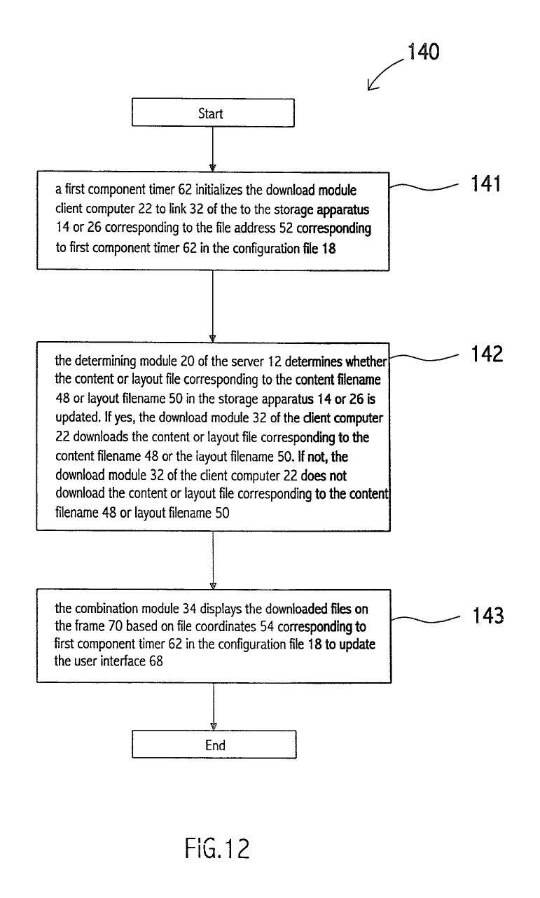

Refers to FIG. 12, it illustrates a flow chart of a seventh method 140 for updating user interface 68 according to the present invention. The configuration file 18 comprises a plurality of first component timers 62. Each of the first component timers 62 corresponds to a content filename 48 or a layout filename 50. The seventh method 140 comprises the following steps.

At step 141, a first component timer 62 initializes the download module 32 of the client computer 22 to link to the storage apparatus 14 or 26 corresponding to the file address 52 corresponding to first component timer 62 in the configuration file 18.

At step 142, the determining module 20 of the server 12 determines whether the content or layout file corresponding to the content filename 48 or layout filename 50 in the storage apparatus 14 or 26 is updated. If yes, the download module 32 of the client computer 22 downloads the content or layout file corresponding to the content filename 48 or the layout filename 50. If not, the download module 32 of the client computer 22 does not download the content or layout file corresponding to the content filename 48 or layout filename 50.

At step 143, the combination module 34 displays the downloaded files on the frame 70 based on file coordinates 54 corresponding to first component timer 62 in the configuration file 18 to update the user interface 68.

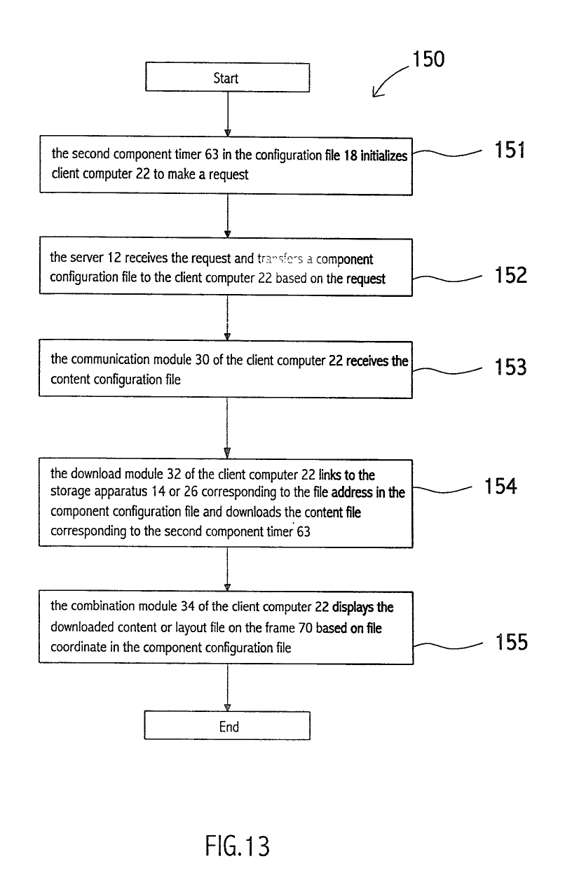

Refers to FIG. 13, it illustrates a flow chart of an eighth method 150 for updating the user interface 68 according to the present invention. The configuration file 18 comprises a plurality of second component timers 63, and each of the second component timers 63 corresponds to a content filename 48 or a layout filename 50. The eighth method 150 comprises the following steps.

At step 151, the second component timer 63 in the configuration file 18 initializes client computer 22 to make a request.

At step 152, the server 12 receives the request and transfers a component configuration file to the client computer 22 based on the request. This component configuration file comprises a content filename 48 or layout filename 50 corresponding to the second component timer 63, a file address and a file coordinate. The file address corresponds to a storage apparatus 14 or 26 where the content or layout file corresponding to the second component timer 63 is located, and the file coordinate is used to designate the location of the content or layout file on the frame 70.

At step 153, the communication module 30 of the client computer 22 receives the content configuration file.

At step 154, the download module 32 of the client computer 22 links to the storage apparatus 14 or 26 corresponding to the file address in the component configuration file and downloads the content file corresponding to the second component timer 63.

At step 155, the combination module 34 of the client computer 22 displays the downloaded content or layout file on the frame 70 based on file coordinate in the component configuration file.

The composition components of the user interface 68 comprise the background, image 74a to 74e, and function buttons 71a to 71c and 76a to 76g of layout 72; as well as the background and 75a to 75d of the content 74. The server 12 controls the client computer 22 with the first or second component timer 62, 63 to update automatically the composition component corresponding to first or second component timer 62, 63.

In the seventh method 140, the server 12 updates the content or layout file stored in the storage apparatus 14 or 26 at preset times and uses the first component timer 62 to control the client computer 22 to download the updated content or layout file in the same storage apparatus. The client computer then displays the updated content or layout file on the frame 70 to replace the previous content or layout file. For example, the server 12 can update the function button 71a with the first component timer 62, which corresponds to function button 71a.

In the eighth method 150, by using the second component timer 63, the server 12 enables the client computer 22 to make a request for changing one of the composition components of user interface 68. Based on the request, server 12 transfers a component configuration file to the client computer 22 to enable it to download different content or layout file and substitute previous content or layout file on the frame 70. For example, with the second component timer 63 corresponding to the function button 71a, the server 12 can update function button 71a.

The ninth method for updating the user interface 68 enables the client computer 22 to make a request by using a user interface driver module 38 of the client computer 22, whereby system 10 repeats the method 80 and generates a new user interface 68.

When the users from the client computer 22 in system 10 click the function button 71a, the client computer 22 generates a selection menu. On the menu, there are different user interface options to choose from, such as a user interface for a news repoter and a stock quote reporter etc. After selecting the user interface, the client computer 22 makes a request to server 12, which as a result transfers a configuration file based on the selected option and generates the user interface required.

When the system 10 is set as a stock quote reporter, it allows the users to select interface patterns such as different cartoon characters, for example a Pokemon etc. Consequently, the users can select the user interface pattern that meets their own particular preference.

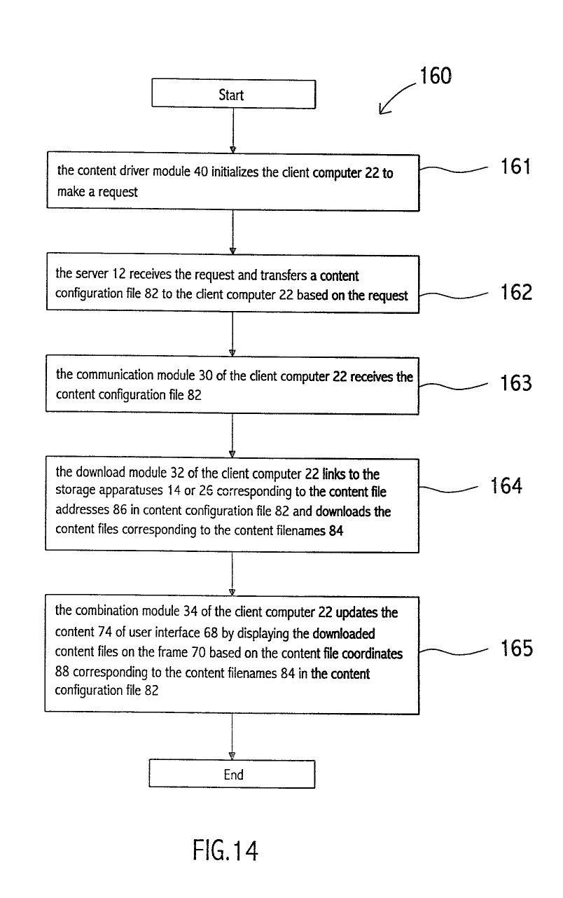

Refers to FIG. 14 and FIG. 8, FIG. 14 illustrates a flow chart of a tenth method 160 for updating the user interface 68 and FIG. 8 illustrates a diagram of a content configuration file 82. The tenth method 160 comprises the following steps.

At step 161, the content driver module 40 initializes the client computer 22 to make a request.

At step 162, the server 12 receives the request and transfers a content configuration file 82 to the client computer 22 based on the request. The content configuration file 82 comprises a plurality of content filenames 84, a plurality of content file addresses 86 and a plurality of content file coordinates 88. Each of the content filenames 84 corresponds to one content file address 86 and one content file coordinates 88. Each of the content file addresses 86 corresponds to a storage apparatus 14 or 26, where the content file corresponding to the content filename 84 is located. The content file coordinates 88 are used to designate the locations of the content files on the frame 70.

At step 163, the communication module 30 of the client computer 22 receives the content configuration file 82.

At step 164, the download module 32 of the client computer 22 links to the storage apparatuses 14 or 26 corresponding to the content file addresses 86 in content configuration file 82 and downloads the content files corresponding to the content filenames 84.

At step 165, the combination module 34 of the client computer 22 updates the content 74 of user interface 68 by displaying the downloaded content files on the frame 70 based on the content file coordinates 88 corresponding to the content filenames 84 in the content configuration file 82.

The system 10 provides the following features. As users from client computer 22 click the functional buttons 71b, the client computer 22 generates a preference panel, where various content options are offered. For example, the user interface of a news reporter provides different news topics to choose from, such as entertainment, politics topics etc. The user interface of a stock quote reporter provides listed companies for stock quotes to choose from. As the users select their preferred content option, the client computer 22 makes a request to the server 12, which comprises the preferred content option. Then, the content of the user interface is changed based on the user's option.

Moreover, the user interface of a news reporter also provides page up, page down function buttons for news content selection. Therefore, as the users from the client computer 22 click the page up function button, the client computer 22 makes a request to server 12 regarding the page up function button so that the previous news content is retrieved.

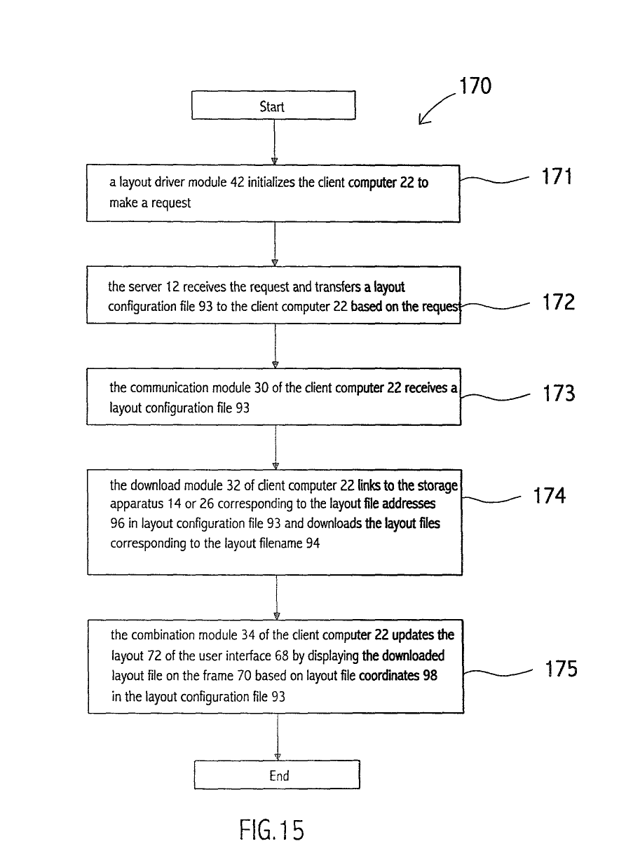

Refers to FIG. 15 and FIG. 11, FIG. 15 illustrates a flow chart of an eleventh method 170 for updating the user interface 68 and FIG. 11 illustrates a diagram of a layout configuration file 93. The eleventh method 170 comprises the following steps.

At step 171, a layout driver module 42 initializes the client computer 22 to make a request.

At step 172, the server 12 receives the request and transfers a layout configuration file 93 to the client computer 22 based on the request. The layout configuration file 93 comprises a plurality of layout filenames 94, a plurality of layout file addresses 96 and a plurality of layout file coordinates 98. Each of the layout filenames 94 corresponds to one layout file address 96 and one layout file coordinates 98. Each of the layout file addresses 96 corresponds to a storage apparatus 14 or 26, where the layout file corresponding to the layout filename 94 is located, and the layout file coordinates 98 are used to designate the location of the layout file on the frame 70.

At step 173, the communication module 30 of the client computer 22 receives a layout configuration file 93.

At step 174, the download module 32 of client computer 22 links to the storage apparatus 14 or 26 corresponding to the layout file addresses 96 in layout configuration file 93 and downloads the layout files corresponding to the layout filename 94.

At step 175, the combination module 34 of the client computer 22 updates the layout 72 of the user interface 68 by displaying the downloaded layout file on the frame 70 based on layout file coordinates 98 in the layout configuration file 93.

The system 10 provides the following features. As the users from the client computer 22 click the functional buttons 71c, a preference panel is generated on the screen of the client computer 22. Various layout options are offered on the panel, such as various cartoon character backgrounds for users to choose from. Accordingly, as the user selects a preferred layout option, the client computer 22 then makes a request to server 12. The layout option selected is included in the request. As a result, a new layout is generated based on the user's preference.

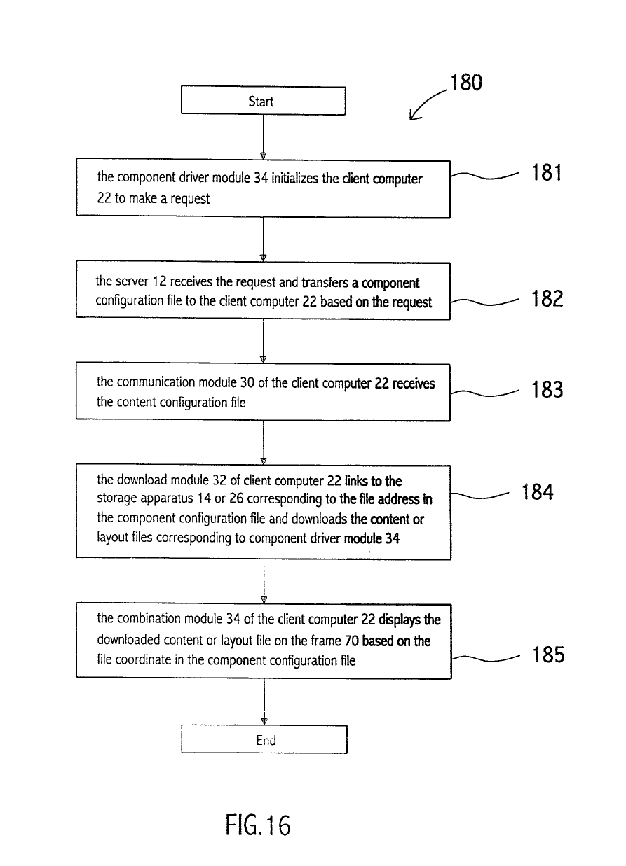

Refers to FIG. 16, it illustrates a flow chart of a twelfth method 180 for updating the user interface 68. The client computer 22 comprises a plurality of component driver modules 34. Each of the component driver modules 34 corresponds to one content filename 48 or one layout filename 50. The twelfth method 180 comprises the following steps.

At step 181, the component driver module 34 initializes the client computer 22 to make a request.

At step 182, the server 12 receives the request and transfers a component configuration file to the client computer 22 based on the request. The component configuration file comprises a content or layout filename, a file address and a file coordinate corresponding to the component driver module 34. The file address corresponds to a storage apparatus 14 or 26, where the content or layout file corresponding to component driver module 34 is located. The file coordinate is used to designate the location of the content or layout file on the frame 70.

At step 183, the communication module 30 of the client computer 22 receives the content configuration file.

At step 184, the download module 32 of client computer 22 links to the storage apparatus 14 or 26 corresponding to the file address in the component configuration file and downloads the content or layout files corresponding to component driver module 34.

At step 185, the combination module 34 of the client computer 22 displays the downloaded content or layout file on the frame 70 based on the file coordinate in the component configuration file.

The system 10 provides the following features. As the user from the client computer 22 moves the cursor onto a component of the user interface 68 and clicks the right button of the computer mouse, the client computer 22 generates a preference panel. For example, as the user move the cursor onto one image or function button and clicks on the right button of the mouse, a preference panel is generated for the user to select his/her preference regarding shape, pattern or color for image or function button. In the same way, if the user desires to select other content options, he/she moves the cursor onto the content display region, clicks the right button of the mouse and selects his/her preferred content option. If the preference concerns the background color, the user moves the cursor onto the background section and clicks the right button of the mouse. A preference penal is then generated for the user to select the desired color option for the background. After each selection is finished, the client computer 22 makes a request to server 12. The request comprises the selection made. Accordingly, the user interface is updated based on the user's selection.

The invention provides a method and system to dynamically update a user interface. The files used to generate a user interface are stored in the server or an external server. Therefore, the server controls the user interface displayed on the client computer. The invention enables an interrelation between the content part user and layout part of the interface. For example, when a story with a title “Government Releases Rules for Online Stock Transactions” is diaplyed on the content of the news reporter, the server 12 can change the layout of the user interface by displaying function buttons related to some stock-brokers. Therefore, the user can click the function buttons to link to the websites of the stock-brokers for accessing the services available.

With the invention, when the user interface is updated, for example, new functions are added to the application, the user can instantly obtain a new user interface.

Furthermore, the users can choose and individualize the user interface to meet their demands and preferences by using the driver modules of the system according to the present invnetion.

The above description explains a method to generate and update a user interface. The system in the invention is designed to support multiple user interfaces from the client computer as well as the update of user interfaces. For example, multiple user interfaces for a stock quote reporter with different content and layout are displayed from the client computer. The content of each of the user interface for a stock quote reporter corresponds to the stock quote of a listed company, whereas the layout of the user interface for the stock quote reporter is subject to the nature of the company or the industry the company belongs to. Such features enable the users to receive the stock quotes for several companies at the same time. The invention is also designed to enable the user to decide which stock quotes to receive.

Moreover, the system in the invention also allows a user interface for a stock market analysis reporter to be generated simultaneously while the user interface of a news reporter displays a story about the stock market from the client computer. The content of the stock market analysis reporter is directly related to the story.

Thus, while there have been shown and described and pointed out fundamental novel features of the invention as applied to preferred embodiments thereof, it will be understood that various omissions and substitutions and changes in the form and details of the disclosed invention may be made by those skilled in the art without departing from the spirit of the invention. It is the intention, therefore, to be limited only as indicated by the scope of the claims appended hereto.

What is claimed is:

1. A method for generating user interfaces, comprising:
(a) making a request from a client computer;
(b) receiving the request at a server end and according to the request transferring a frame and a configuration file from the server end to the client computer, the configuration file comprising a plurality of filenames, a plurality of file addresses and a plurality of file coordinates, wherein each of the filenames corresponds to one file address and one file coordinate, each of the file addresses corresponds to a storage apparatus where the file corresponding to the filename is located and the file coordinate is used to designate the location of the file on the frame; and
(c) receiving the frame and the configuration file from the client computer; and
(d) linking to the storage apparatus corresponding to the file addresses and downloading the files corresponding to the filenames according to the file addresses corresponding to the filenames in the configuration file from the client computer; and
(e) generating a user interface on the frame by displaying the files downloaded from the client computer based on the file coordinates corresponding to the filenames in the configuration file.

2. The method of claim 1, wherein the user interface comprises a content part and a layout part, and the filenames comprises a plurality of content filenames and a plurality of layout filenames, content files corresponding to the content filenames are used for generating the content part of the user interface, and layout files corresponding to the layout filenames are used for generating the layout part of the user interface.

3. The method of claim 1 further comprising:
(f) deleting the gap between the frame and the user interface and displaying the overlapping display region of the user interface and the frame from the client computer when the display region of the frame is larger than the display region of the user interface.

4. The method of claim 1, wherein the configuration file further comprises a plurality of margin coordinates for locating the display region of the frame, the method further comprising:
(f) forming a margin on the frame from the client computer based on the margin coordinates and deleting the display region of the frame beyond the margin.

5. The method of claim 1, wherein the configuration file further comprises a timer for initializing the client computer at preset times to execute the method for updating the user interface, the method comprising steps (d) to (e).

6. The method of claim 1, wherein the configuration file further comprises a timer for initializing the client computer at preset times to execute the method for updating the user interface, the method comprising the following steps:
linking to the storage apparatus corresponding to the file addresses based on the file addresses corresponding to the filenames in the configuration file from the client computer:
determining whether the files corresponding to the filenames in the storage apparatus being updated, if yes, the client computer downloading the updated files corresponding to the filenames, if not, the client computer not downloading the files corresponding to the filenames; and
displaying the downloaded files on the frame to update the user interface based on the file coordinates corresponding to the filenames in the configuration file from the client computer.

7. The method of claim 1, wherein the configuration file further comprises a timer for initializing the client computer at preset times to execute the method for updating the user interface, the method comprising steps (a) to (e).

8. The method of claim 1, wherein the storage apparatus is an external server.

9. The method of claim 1, wherein the server comprises the storage apparatus.

10. The method of claim 2, wherein the configuration file further comprises a first timer corresponding to the content filenames for initializing the client computer at preset times to execute the method for updating the user interface, the method comprising following steps:
linking to the storage apparatus corresponding to the file addresses and downloading the content files corresponding to the content filenames according to the file addresses corresponding to the content filenames in the configuration file from the client computer; and
displaying the downloaded content files to update the user interface on the frame based on the content file coordinates corresponding to the content filenames in the configuration file from the client computer.

11. The method of claim 2, wherein the configuration file further comprises a first timer corresponding to the content filenames for initializing the client computer at preset times to execute the method for updating the user interface, the method comprising following steps:
linking to the storage apparatus corresponding to the file addresses according to the file addresses corresponding to the content filenames in the configuration file from the client computer;
determining whether the content files corresponding to the content filenames in the storage apparatus being updated, if yes, the client computer downloading the updated content files corresponding to the content filenames, if not, the client computer not downloading the content files corresponding to the content filenames; and
displaying the downloaded content files on the frame to update the user interface based on the content file coordinates corresponding to the content filenames in the configuration file from the client computer.

12. The method of claim 2, wherein the configuration file further comprises a first timer for initializing the client computer at preset times to execute the method for updating the user interface, the method comprising following steps:
making a request from the client computer;
receiving the request at the server end and according to the request transferring a frame and a content configuration file from the server end to the client computer, the content configuration file comprising a plurality of content filenames, a plurality of content file addresses and a plurality of content file coordinates, wherein each of the content filenames corresponds to one of the content file addresses and one of the content file coordinates, each of the content file addresses corresponds to one storage apparatus where the content file corresponding to the content filename is located, and the content file coordinates are used to designate the locations of the content files on the frame;
receiving the frame and the content configuration file from the client computer;
linking to the storage apparatus corresponding to the content file addresses and downloading the content files corresponding to the content filenames according to the content file addresses corresponding to the content filenames in the content configuration file from the client computer; and
displaying the downloaded content files on the frame to update the content of the user interface from the client computer based on the content file coordinates corresponding to the content filenames in the content configuration file.

13. The method of claim 2, wherein the configuration file further comprises a second timer corresponding to the layout filenames for initializing the client computer at preset times to execute the method for updating the user interface, the method comprising the following steps:
linking to the storage apparatus corresponding to the file addresses and downloading the layout files corresponding to the layout filenames according to the file addresses corresponding to the layout filenames in the configuration file from the client computer; and
displaying the downloaded layout file on the frame to update the user interface based on the layout file coordinates corresponding to the layout filenames in the configuration file from the client computer.

14. The method of claim 2, wherein the configuration file further comprises a second timer corresponding to the layout filenames for initializing the client computer at preset times to execute the method for updating the user interface, the method comprising following steps:
linking to the storage apparatus corresponding to the file addresses based on the file addresses corresponding to the layout filenames in the configuration file from the client computer;
determining whether the layout files corresponding to the layout filenames in the storage apparatus being updated, if yes, the client computer downloading the updated layout files corresponding to the layout filenames, if not, the client computer not downloading the layout files corresponding to the layout filenames; and
displaying the downloaded layout files on the frame to update the user interface based on the file coordinates corresponding to the layout filenames in the configuration file from the client computer.

15. The method of claim 2, wherein the configuration file further comprises a second timer for initializing the client computer at preset times to execute the method for updating the user interface, the method comprising following steps:
making a request from the client computer;
receiving the request at the server end and according to the request transferring a frame and a layout configuration file from the server end to the client computer, the layout configuration file comprising a plurality of layout filenames, a plurality of layout file addresses and a plurality of layout file coordinates, wherein each of the layout filenames corresponds to one of the layout file addresses and one of the layout file coordinates, each of the layout file addresses corresponds to the storage apparatus where the layout file corresponding to the layout filename is located, and the layout file coordinates are used to designate the locations of the layout files on the frame;
receiving the frame and the layout configuration file from the client computer;
linking to the storage apparatus corresponding to the layout file addresses and downloading the layout files corresponding to the layout filenames according to the layout file addresses in the layout configuration file from the client computer; and
displaying the downloaded layout files on the frame to update the layout of the user interface based on the layout file coordinates corresponding to the layout filenames in the layout configuration file from the client computer.

16. The method of claim 1, wherein the configuration file further comprises a plurality of timers, each of the timers corresponding to one of the filenames for initializing the client computer at preset times to execute the method for updating the user interface, the method comprising the following steps:
linking to the storage apparatus corresponding to the file address and downloading the file corresponding to the filename according to the file address corresponding to the timer in the configuration file from the client computer; and
displaying the downloaded file on the frame to update the user interface based on the file coordinate corresponding to the filename in the configuration file from the client computer.

17. The method of claim 1, wherein the configuration file further comprises a plurality of timers, each of the timers corresponding to one of the filenames for initializing the client computer at preset times to execute the method for updating the user interface, the method comprising the following steps:
linking to the storage apparatus corresponding to the file address and downloading the files corresponding to the filename according to the file address corresponding to the timer in the configuration file from the client computer;
determining whether the file corresponding to the filename in the storage apparatus being updated, if yes, the client computer downloading the file corresponding to the filename, if not, the client computer not downloading the file corresponding to the filename; and
displaying the downloaded file on the frame to update the user interface based on the file coordinate corresponding to the filename in the configuration file from the client computer.

18. The method of claim 1, wherein the configuration file further comprises a plurality of timers, each of the timers corresponding to one of the filename for initializing the client computer at preset times to execute the method for updating the user interface, the method comprising the following steps:
making a request from the client computer;
receiving the request at the server end and according to the request transferring a component configuration file from the server end to the client computer, the component configuration file comprising the filename, a file address corresponding to the filename and a file coordinate corresponding to the filename, the file address corresponding to a storage apparatus where the file corresponding to the filename being located, and the file coordinate being used to designate the location of the configuration file on the frame; receiving the frame and the component configuration file from the client computer;
linking to the storage apparatus corresponding to the file address and downloading the file corresponding to the filename according to the file address corresponding to the filename in the component configuration file from the client computer; and
displaying the downloaded file on the frame to update the user interface based on file coordinate in the component configuration file from the client computer.

19. The method of claim 1, wherein the client computer further comprises a driver module used to enable the client computer to execute the method to update the user interface from the client computer, the method comprising steps (a) to (e).

20. The method of claim 2, wherein the client computer further comprises a first driver module used to enable the client computer to execute the method for updating the user interface from the client computer, the method comprising the following steps:
making a request from the client computer;
receiving the request at the server end and according to the request transferring a frame and a content configuration file from the server end to the client computer, the content configuration file comprising a plurality of content filenames, a plurality of content file addresses and a plurality of content file coordinates, wherein each of the content filenames corresponds to one of the content file addresses and one of the content file coordinates, each of the content file addresses corresponds to the storage apparatus where the content files corresponding to the content filenames are located, and the content file coordinates are used to designate the locations of the content files on the frame; and
receiving the frame and the content configuration file from the client computer; and
linking to the storage apparatus corresponding to the content file addresses and downloading the content files corresponding to the content filenames according to the content file addresses in the content configuration file from the client computer; and
displaying the downloaded content files on the frame to update the content of the user interface from the client computer based on the content file coordinates corresponding to the content filenames in the content configuration file.

21. The method of claim 2, wherein the client computer further comprises a second driver module used to enable the client computer to execute the method for updating the user interface from the client computer, the method comprising following steps:
making a request from the client computer;
receiving the request at the server end and according to the request transferring a frame and a layout configuration file from the server end to the client computer, the layout configuration file comprising a plurality of layout filenames, a plurality of layout file addresses and a plurality of layout file coordinates, wherein each of the layout filenames corresponds to one of the layout file addresses and one of the layout file coordinates, each of the layout file addresses corresponds to the storage apparatus where the layout files corresponding to the layout filenames are located, and the layout file coordinates are used to designate the locations of the layout files on the frame; and
receiving the frame and the layout configuration file from the client computer; and
linking to the storage apparatus corresponding to the layout file addresses and downloading the layout files corresponding to the layout filenames according to the layout file addresses in the layout configuration file from the client computer; and
displaying the downloaded layout files on the frame to update the layout of the user interface from the client computer based on the layout file coordinates corresponding to the layout filenames in the layout configuration file.

22. The method of claim 1, wherein the client computer further comprises a plurality of driver modules, each of the driver modules corresponds to one of the filenames used to enable the client computer to execute the method for updating the user interface, the method comprising the following steps:
making a request from a client computer;
receiving the request at a server end and according to the request transferring a component configuration file from the server end to the client computer, the component configuration file comprising the filename, a file address corresponding to the filename and a file coordinate corresponding to the filename, the file address corresponds to a storage apparatus where the file corresponding to the filename is located, and the file coordinate is used to designate the location of the file on the frame;
linking to the storage apparatus corresponding to the file address and downloading the file according to the file address corresponding to the filename in the component configuration file from the client computer; and displaying the downloaded file on the frame based on the file coordinate in the component configuration file to update the user interface from the client computer.

23. A system for generating user interfaces, comprising:
a server, comprising:
a frame module used to generate a frame; and a plurality of configuration files, each of the configuration files having a plurality of filenames, a plurality of file addresses and a plurality of file coordinates, wherein each of the filenames corresponds to one of the file addresses and one of the file coordinates, each of the file addresses corresponds to a storage apparatus where the file corresponding to the filename is located, and the file coordinates are used to designate the locations of the files on the frame;
a client computer, comprising:
a communication module for receiving the frame and the configuration files from the server;
a download module for linking to the storage apparatus corresponding to the file addresses and downloading the files corresponding to the filenames according to the file addresses in the configuration file; and
a combination module for displaying the downloaded files on the frame to update the user interface based on the file coordinates corresponding to the filenames in the configuration file.

24. The system of claim 23, wherein the user interface comprises a content part and a layout part, and the filenames comprises a plurality of content filenames and a plurality of layout filenames, content files corresponding to the content filenames are used for generating the content part of the user interface, and layout files corresponding to the layout filenames are used for generating the layout part of the user interface.

25. The system of claim 23, wherein the client computer further comprises: a re-shaping module for deleting the display region of the frame which is beyond the overlapping display region of the user interface and the frame.

26. The system of claim 23, wherein the configuration file further comprises a plurality of margin coordinates for designating the display region of the frame, the client computer further comprises: a re-shaping module for forming a margin on the frame based on the margin coordinates and deleting the display region of the frame beyond the margin.

27. The system of claim 23, wherein the configuration file further comprises a timer used to initialize the download module and the combination module of the client computer at preset times.

28. The system of claim 27, wherein the server further comprises a determining module, when the download module of the client computer is initialized to link to the storage apparatus according to the file address corresponding to the filename in the configuration file, the determining module determines whether the file corresponding to the filename in the storage apparatus is updated, if yes, the client computer downloads the file corresponding to the filename, if not, the client computer does not download the file corresponding to the filename.

29. The system of claim 23, wherein the configuration file further comprises a timer used to initialize the communication module, the download module and the combination module of the client computer at preset times.

30. The system of claim 23, the storage apparatus is an external server.

31. The system of claim 23, wherein the server further comprises the storage apparatus.

32. The system of claim 24, wherein the configuration file further comprises a first timer corresponding to the content filenames used for:
initializing the download module of the the client computer to link to the storage apparatus corresponding to the file addresses and download the content files corresponding to the content filenames according to the file addresses in the configuration file; and
initializing the combination module of the client computer to display the downloaded content files on the frame to update the content part of the user interface based on the content file coordinates corresponding to the content filenamse in the content configuration file.

33. The system of claim 32, wherein the server further comprises a determining module, when the download module of the client computer is initialized to link to the storage apparatus according to the content file address corresponding to the content filename in the configuration file, the determining module determines whether the content file corresponding to the content filename in the storage apparatus is updated, if yes, the client computer downloads the content file corresponding to the content filename, if not, the client computer does not download the content file corresponding to the content filename.

34. The system of claim 24, wherein the configuration file further comprises a first timer for:
initializing the communication module of the client computer at preset times to receive a content configuration file from the server, the content configuration file comprising a plurality of content filenames, a plurality of content file addresses and a plurality of content file coordinates, wherein each content filename corresponds to one of the content file addresses and one of the content file coordinates, each content file address corresponds to the storage apparatus where the content file corresponding to the content filename is located, and the content file coordinates are used to designate the locations of the content files on the frame;
initializing the download module of the client computer to link to the storage apparatus corresponding to the file addresses and download the content files corresponding to the content filenames according to the file addresses in the configuration file; and
initializing the combination module of the client computer to display the downloaded content files on the frame to update the content part of the user interface based on the content file coordinates corresponding to the content filenames in the content configuration file.

35. The system of claim 24, wherein the configuration file further comprises a second timer corresponding to the layout filenames used for:
initializing the download module of the client computer to link to the storage apparatus corresponding to the file addresses and download the layout files corresponding to the layout filenames according to the file addresses in the configuration file; and
initializing the combination module of the client computer to display the downloaded layout files on the frame to update the layout part of the user interface based on the file coordinates corresponding to the layout filenames in the layout configuration file.

36. The system of claim 35, wherein the server further comprises a determining module to determine whether the file which corresponds to the layout filename in the storage apparatus is updated, thereupon the client computer is initialized by the download module and links to the storage apparatus corresponding to the file address according to the file address corresponding to the layout filename in the component configuration file; if yes, the client computer downloads the layout file which corresponds to the layout filename, if not, the client computer does not download the layout file which corresponds to the layout filename.

37. The system of claim 24, wherein the configuration file further comprises a second timer for:
initializing the communication module at preset times to receive a layout configuration file from the server from the client computer; the layout configuration file comprising a plurality of layout filenames, a plurality of layout file addresses and a plurality of layout file coordinates, wherein each layout filename corresponds to the layout file address and the layout file coordinates, each layout file address corresponds to the storage apparatus where the layout files corresponding to the layout filenames are located and layout file coordinates are used to locate the layout configuration file on the frame;
initializing the download module to link to the storage apparatus corresponding to the file address and download the layout file corresponding to the layout filename according to the layout file address corresponding to each layout filename in the layout configuration file from the client computer; and
initializing the combination module to display the downloaded layout file by updating the layout part of the user interface based on layout file coordinates corresponding to the layout filename in the layout configuration file from the client computer.

38. The system of claim 23, wherein the configuration file further comprises a plurality of timers, each timer corresponding to a filename for:
initializing the download module to link to the storage apparatus corresponding to the file address and download the file corresponding to the filename according to the file address corresponding to the filename in the configuration file from the client computer; and
initializing the combination module to display the downloaded file on the frame based on file coordinates corresponding to the filename in the configuration file from the client computer.

39. The system of claim 38, wherein the server further comprises a determining module, when the download module of the client computer is initialized to link to the storage apparatus according to the file address corresponding to the filename in the configuration file, the determining module determines whether the file corresponding to the filename in the storage apparatus is updated, if yes, the client computer downloads the file corresponding to the filename, if not, the client computer does not download the file corresponding to the filename.

40. The system of claim 23, wherein the configuration file further comprises a plurality of timers, each of the timers is corresponding to one of the filenames and is used for:
initializing the communication module of the client computer at preset times to receive a configuration file from the server, the configuration file comprising the filename, a file address corresponding to the filename and a file coordinate corresponding to the filename, the file address corresponds to a storage apparatus where the file corresponding to the filename is located, and the file coordinate is used to designate the location of the file on the frame;
initializing the download module of the client computer to link to the storage apparatus corresponding to the file address and download the file corresponding to the filename according to the file address in the configuration file; and
initializing the combination module of the client computer to display the downloaded file on the frame based on the file coordinate in the configuration file.

41. The system of claim 23, wherein the client computer comprises a driver module used to initialize the communication modules, the download module and the combination module at preset times from the client computer.

42. The system of claim 24, wherein the client computer further comprises a first driver module for:
initializing the communication module of the client computer to receive a content configuration file from the server, the content configuration file comprising a plurality of content filenames, a plurality of content file addresses and a plurality of content file coordinates, wherein each content filename corresponds to one of the content file addresses and one of the content file coordinates, each content file address corresponds to the storage apparatus where the content file corresponding to the content filename is located, and the content file coordinates are used to designate the locations of the content files on the frame;
initializing the download module of the client computer to link to the storage apparatus corresponding to the file addresses and download the content files corresponding to the content filenames according to the file addresses in the configuration file; and
initializing the combination module of the client computer to display the downloaded content files on the frame to update the content part of the user interface based on the content file coordinates corresponding to the content filenames in the content configuration file.

43. The system of claim 24, wherein the client computer further comprises a second driver module for:
initializing the communication module of the client computer to receive a layout configuration file from the server, the layout configuration file comprising a plurality of layout filenames, a plurality of layout file addresses and a plurality of layout file coordinates, wherein each layout filename corresponds to one of the layout file addresses and one of the layout file coordinates, each layout file address corresponds to the storage apparatus where the layout file corresponding to the layout filename is located, and the layout file coordinates are used to designate the locations of the layout files on the frame;
initializing the download module of the client computer to link to the storage apparatus corresponding to the file addresses and download the layout files corresponding to the layout filenames according to the file addresses in the configuration file; and
initializing the combination module of the client computer to display the downloaded layout files to update the layout part of the user interface based on the layout file coordinates corresponding to the layout filenames in the layout configuration file.

44. The system of claim 23, wherein the client computer further comprises:
a plurality of driver modules, each of the driver modules is corresponding to one of the filenames and is used for initializing the communication module of the client computer so as to receive a component configuration file from the server end, the component configuration file comprises the filename corresponding to the driver module, a file address corresponding to the filename and a file coordinate corresponding to the filenam, the file address corresponds to a storage apparatus where the file corresponding to the filename is located, and the file coordinate is used to designate the location of the file on the frame;
initializing the download module of the client computer and according to the file address corresponding to the filename in the component configuration file, the download module linking to the storage apparatus corresponding to the file address and downloading the file corresponding to the filename; and initializing the combination module of the client computer to display the downloaded file on the frame according to the file coordinate in the component configuration file.
